(19) United States
(12) Patent Application Publication
(10) Pub. No.: US 2020/0086774 A1
(43) Pub. Date: Mar. 19, 2020

(54) SEAT AIR-CONDITIONING DEVICE

(71) Applicant: DENSO CORPORATION, Kariya-city, (JP)

(72) Inventors: Akane MUTO, Kariya-city (JP); Teruyuki HOTTA, Kariya-city (JP); Tatsuhiro SUZUKI, Kariya-city (JP); Riho WATANABE, Kariya-city (JP); Shigeru KAWANO, Kariya-city (JP)

(21) Appl. No.: 16/694,901

(22) Filed: Nov. 25, 2019

Related U.S. Application Data
(63) Continuation of application No. PCT/JP2018/020709, filed on May 30, 2018.

(30) Foreign Application Priority Data
Jun. 20, 2017 (JP) 2017-120149
Apr. 25, 2018 (JP) 2018-083816

(51) Int. Cl. B60N 2/56; B60H 1/00

(52) U.S. Cl. CPC B60N 2/5628; B60H 1/00285; B60H 2001/003; B60H 2001/0015; B60H 1/00878

(57) ABSTRACT

In a seat air-conditioning device, a refrigeration cycle, a warm air blower, and a cold air blower are housed in a housing disposed between a seat face of a seat and a vehicle interior floor. A condenser is disposed on an upstream side in an air blowing direction and the warm air blower is disposed on a downstream side in an air blowing direction in a warm air flow path extending in a predetermined direction. An evaporator is disposed on a downstream side of the cold air blower in an air blowing direction in the cold air flow path extending in a predetermined direction.

### CROSS REFERENCE TO RELATED APPLICATION

The present application is a continuation application of International Patent Application No. PCT/JP2018/020709 filed on May 30, 2018, which designated the U.S. and claims the benefit of priority from Japanese Patent Applications No. 2017-120149 filed on Jun. 20, 2017 and No. 2018-083816 filed on Apr. 25, 2018. The entire disclosures of all of the above applications are incorporated herein by reference.

### TECHNICAL FIELD

The present disclosure relates to a seat air-conditioning device for supplying conditioned air to a seat.

### BACKGROUND

A seat air-conditioning device may be disposed between a seat face of a seat and a floor of a vehicle and may include a vapor compression refrigeration cycle in a housing. The seat air-conditioning device is formed to blow out conditioned air, at a temperature adjusted by operation of the refrigeration cycle, toward an occupant sitting in the seat. The conditioned air in this case is warmed or cooled by heat exchange in a condenser or an evaporator of the refrigeration cycle.

### SUMMARY

According to an aspect of the present disclosure, a seat air-conditioning device is for supplying conditioned air to a seat in a vehicle interior. In the seat air-conditioning device, a warm air flow path extends in a predetermined direction in a housing and air warmed by a condenser flows in the warm air flow path. A cold air flow path extends in parallel with the warm air flow path in the housing and air cooled by the evaporator flows through the cold air flow path. A warm air blower is disposed in the warm air flow path and blows air in a predetermined air-blowing direction in the warm air flow path, and a cold air blower is disposed in the cold air flow path and blows air in a predetermined air blowing direction in the cold air flow path. The condenser is disposed in the warm air flow path, and the evaporator is disposed in the cold air flow path. Furthermore, a line connecting the condenser and the evaporator intersects a line connecting the warm air blower and the cold air blower in the housing.

### BRIEF DESCRIPTION OF DRAWINGS

FIG. 1 is a front view of a structure of a seat air-conditioning device according to a first embodiment.

FIG. 2 is a side view of the structure of the seat air-conditioning device according to the first embodiment.

FIG. 3 is a plan view of an internal structure of the seat air-conditioning device according to the first embodiment.

FIG. 4 is a sectional view taken along line IV-IV in FIG. 3.

FIG. 5 is a sectional view taken along line V-V in FIG. 3.

FIG. 6 is a sectional view of an internal structure of a cold air flow path in a seat air-conditioning device according to a second embodiment.

FIG. 7 is a plan view of flows of warm air and cold air in a seat air-conditioning device according to a third embodiment.

### DESCRIPTION OF EMBODIMENTS

Generally, a housing of a seat air-conditioning device is disposed in a limited space between a seat face of a vehicle seat and a vehicle floor and all of various components of the seat air-conditioning device, such as the refrigeration cycle, blowers and the like, are housed in the housing.

For example, a condenser and an evaporator of the refrigeration cycle are disposed close to each other in the housing and likely to be influenced by mutual heat.

Furthermore, the blower for blowing the warm air produced by the condenser and the blower for blowing the cold air produced by the evaporator are respectively disposed in the housing as well. Therefore, the cold air and the warm air conditioned by the refrigeration cycle are expected to flow near the blowers.

In this case, it is necessary to consider influences exerted by heat generated by operation of the respective blowers on the conditioned air at the temperature adjusted by the refrigeration cycle.

The present disclosure relates to a seat air-conditioning device including component devices of a refrigeration cycle and the like housed in a housing, and an objective of the present disclosure is to provide a seat air-conditioning device capable of suppressing a decrease in performance of a refrigeration cycle caused by heat from respective component devices.

According to an aspect of the present disclosure, a seat air-conditioning device is for supplying conditioned air to a seat in a vehicle interior. The seat air-conditioning device includes a housing, a refrigeration cycle, a warm air flow path, a cold air flow path, a warm air blower and a cold air blower. The refrigeration cycle includes a compressor configured to compress and discharge refrigerant, a condenser configured to cause the refrigerant discharged from the compressor to dissipate heat, a pressure reducer configured to reduce a pressure of the refrigerant flowing out of the condenser, and an evaporator configured to evaporate the refrigerant reduced in pressure in the pressure reducer, the refrigeration cycle being disposed in the housing. The warm air flow path extends in a predetermined direction in the housing and through which air warmed by the condenser flows. The cold air flow path extends in parallel with the warm air flow path in the housing and through which air cooled by the evaporator flows. The warm air blower is disposed in the warm air flow path and blows air in a predetermined air-blowing direction in the warm air flow path. The cold air blower is disposed in the cold air flow path and blows air in a predetermined air blowing direction in the cold air flow path. The condenser is disposed in the warm air flow path, and the evaporator is disposed in the cold air flow path. Furthermore, a line connecting the condenser and the evaporator intersects a line connecting the warm air blower and the cold air blower in the housing.

In this way, the seat air-conditioning device can supply the conditioned air to the seat via the warm air flow path and the cold air flow path by operating the refrigeration cycle, the warm air blower, and the cold air blower disposed in the housing. Thus, the seat air-conditioning device can increase comfort of an occupant sitting in the seat with the conditioned air from the housing.

In the housing of the seat air-conditioning device, the condenser, the evaporator, the warm air blower, and the cold air blower are disposed so that a line connecting the condenser and the evaporator intersects a line connecting the warm air blower and the cold air blower. Therefore, according to the seat air-conditioning device, it is possible to put a large distance between the warm air blower and the cold air blower, which generate heat when the warm air blower and the cold air blower operate, in the housing to thereby suppress the decrease in the performance of the refrigeration cycle due to the heat generation of the warm air blower and the cold air blower.

Moreover, according to the seat air-conditioning device, it is possible to put a large distance between the condenser that functions as a heat radiator and the evaporator that functions as a heat absorber in the housing and therefore it is possible to suppress thermal influences of the condenser and the evaporator on each other to thereby suppress the decrease in the performance of the refrigeration cycle. In other words, according to the seat air-conditioning device, it is possible to increase the comfort of the occupant sitting on the seat while suppressing the decrease in the performance of the refrigeration cycle.

In the seat air-conditioning device, the condenser may be disposed on an upstream side in the air blowing direction and the warm air blower may be disposed on a downstream side in the air blowing direction in the warm air flow path. In this case, the blown air that has turned into warm air as a result of passage through the condenser can be warmed by heat generation by the warm air blower.

The cold air blower may be disposed on an upstream side in the air blowing direction and the evaporator may be disposed on a downstream side in the air blowing direction in the cold air flow path. In this case, the cold air having passed through the evaporator can be supplied from the cold air flow path to the seat without being influenced by heat generation by the cold air blower and the like.

Hereinafter, detail embodiments for implementing the present disclosure will be described referring to drawings. In the respective embodiments, a part that corresponds to a matter described in a preceding embodiment may be assigned the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

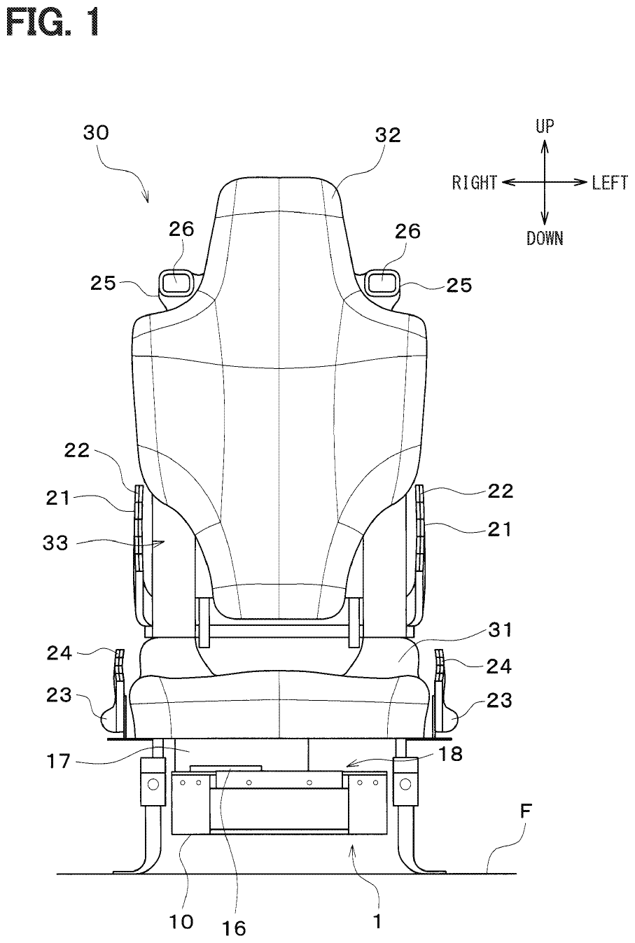

Arrows indicating “up”, “down”, “left”, “right”, “front”, and “rear” in the respective figures show directions seen from eyes of an occupant sitting in a seat 30 of a vehicle. In the respective figures, paper-surface front side and back side are defined with respect to this position as well. For example, the paper-surface front side and back side in FIG. 1 correspond to the front and rear directions.

### First Embodiment

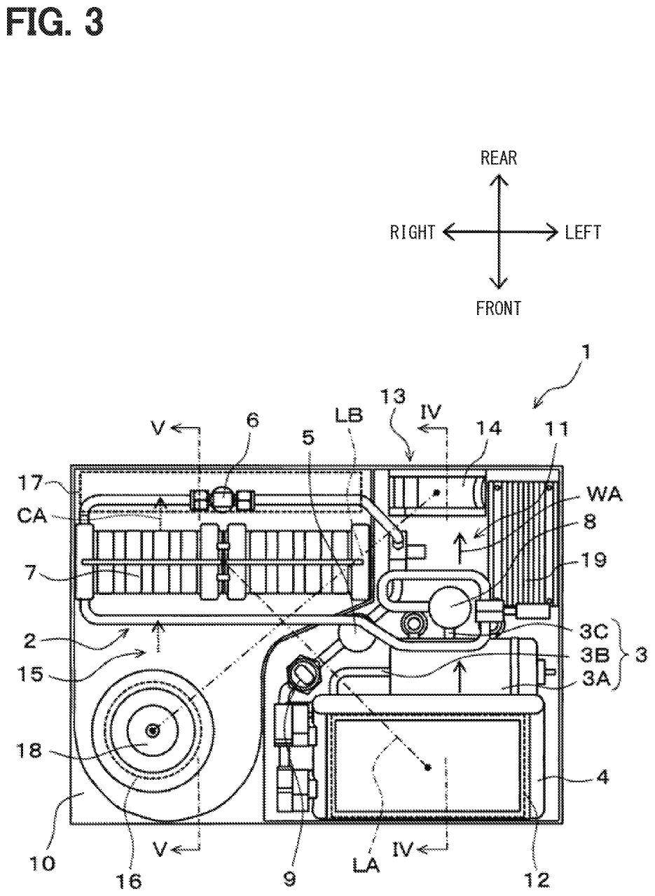

First, a general outline of a seat air-conditioning device 1 according to a first embodiment will be described with reference to FIGS. 1 to 5. To show an inside of a housing 10 forming the seat air-conditioning device 1 in FIG. 3, an upper face of the housing 10 is not shown and opening edges of a warm-air-side intake port 12 and the like formed in the upper face of the housing 10 are shown by broken lines.

The seat air-conditioning device 1 according to the first embodiment is applied to an electric car that travels by using power of a battery. The seat air-conditioning device 1 is disposed at a seat 30 of the electric car and increases comfort of an occupant sitting in the seat 30.

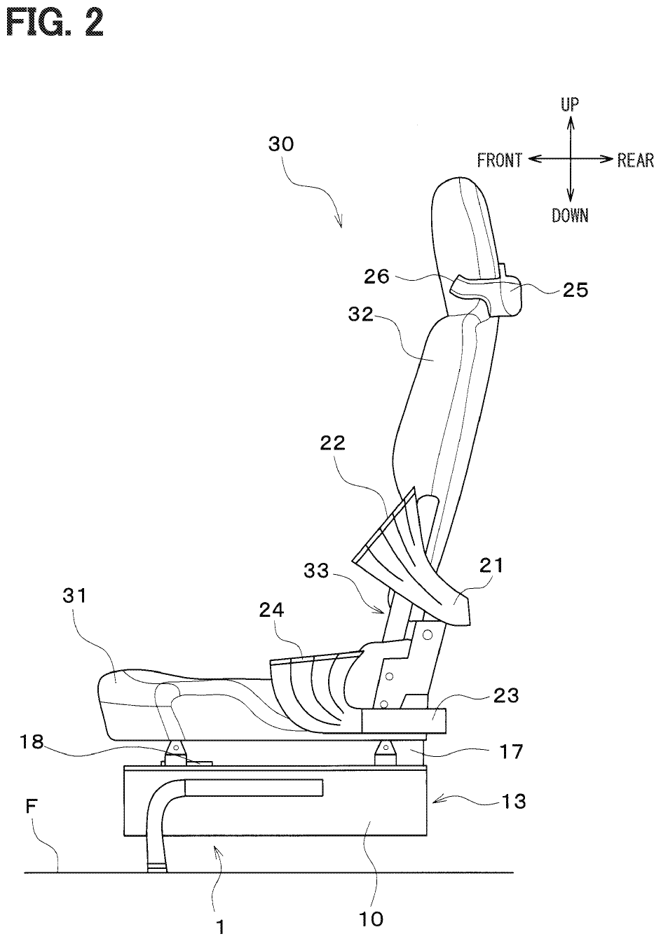

As shown in FIGS. 1 and 2, the seat 30 is disposed in the electric car to provide seating for the occupant and has a seat face 31, a backrest 32, and a seat frame 33. The seat face 31 is a portion, on which the occupant sits, and has a porous cushion on its upper face.

The backrest 32 forms a portion that supports the occupant sitting on the seat face 31 from behind and has a porous cushion on its front face.

The seat frame 33 is formed by assembling metal pipes and functions as a skeletal member of the seat 30. The seat 30 is formed by fixing relative positions of the seat face 31 and the backrest 32 by use of the seat frame 33.

The seat air-conditioning device 1 according to the first embodiment is disposed in a small space between the seat face 31 of the seat 30 formed as described above and a vehicle interior floor F and increases the comfort of the occupant sitting in the seat 30 by supplying conditioned air at an adjusted suitable temperature.

As shown in FIG. 3 and the like, the seat air-conditioning device 1 includes a vapor compression refrigeration cycle 2, a warm air blower 14, a cold air blower 18, and an inverter 19 housed in the housing 10. Therefore, the seat air-conditioning device 1 can adjust temperatures of air, blown by operation of the warm air blower 14 and the cold air blower 18, with the refrigeration cycle 2 and supply the blown air to the occupant sitting in the seat 30 through main ducts 21 and the like disposed on opposite sides of the seat 30.

As described above, the seat air-conditioning device 1 according to the first embodiment includes the various component devices such as the refrigeration cycle 2 and the warm air blower 14 housed in the housing 10 disposed between the seat face 31 of the seat 30 and the vehicle interior floor F.

As shown in FIGS. 1 to 5, the housing 10 is formed in such a rectangular parallelepiped shape that the housing 10 can be disposed between the seat face 31 and the vehicle interior floor F. A height of the housing 10 (i.e., a housing height H) is shorter than a distance between a lower face of the seat 30 and an upper face of the vehicle interior floor F.

The refrigeration cycle 2 includes a compressor 3, a condenser 4, a receiver 5, a pressure reducer 6, an evaporator 7, and a gas-liquid separator 8 and forms the vapor compression refrigeration cycle. The refrigeration cycle 2 performs a function of cooling or heating the blown air blown to an area around the seat 30 in the vehicle interior, which is a space to be air-conditioned, by circulating refrigerant by operation of the compressor 3.

Here, HFC refrigerant (specifically, R134a) is employed as the refrigerant in the refrigeration cycle 2 and the refrigeration cycle 2 forms a vapor compression subcritical refrigeration cycle in which a refrigerant pressure on a high-pressure side does not exceed a critical pressure of the refrigerant. It is of course possible to employ HFO refrigerant (e.g., R1234yf), natural refrigerant (e.g., R744), or the like as the refrigerant. Moreover, refrigerant oil for lubricating the compressor 3 is mixed into the refrigerant and part of the refrigerant oil circulates through the cycle together with the refrigerant.

The compressor 3 draws in, compresses, and discharges the refrigerant in the refrigeration cycle 2 and functions as a compressor in the present disclosure. The compressor 3 is formed as an electric compressor including a fixed capacity compression mechanism, which has a fixed discharge capacity and is driven by an electric motor, and the compressor 3 is disposed in the housing 10 of the seat air-conditioning device 1. As the compression mechanism, various compression mechanisms such as a scroll compression mechanism and a vane compression mechanism can be employed.

Operation (rotation speed) of the electric motor forming the compressor 3 is controlled by control signals output from an air-conditioning controller (not shown). As the electric motor, either one of an AC motor and a DC motor can be employed. The air-conditioning controller controls the rotation speed of the electric motor to thereby change refrigerant discharge performance of the compressor 3.

The compressor 3 includes a main body 3A that houses the above-described compression mechanism and the electric motor, a discharge pipe 3B for discharging the refrigerant compressed in the main body 3A, and a suction pipe 3C through which the refrigerant circulating through the refrigeration cycle 2 is drawn into the main body 3A.

A refrigerant inlet of the condenser 4 is connected to the discharge pipe 3B of the compressor 3. The condenser 4 can cause the high-temperature and high-pressure discharged refrigerant discharged from the compressor 3 and the blown air to exchange heat with each other to thereby heat the blown air. In other words, the condenser 4 operates as a heating heat exchanger and functions as a radiator.

The receiver 5 is connected to a refrigerant outlet of the condenser 4. The receiver 5 is a liquid receiver that separates the refrigerant, flowing out of the condenser 4, into gas and liquid and stores the liquid-phase refrigerant. The receiver 5 can store the high-pressure liquid-phase refrigerant condensed by the condenser 4 as the excess refrigerant in the cycle. In other words, the refrigeration cycle 2 has the receiver 5 to thereby function as what is called a receiver cycle. Therefore, according to the seat air-conditioning device 1, it is possible to evaporate the refrigerant flowing out of the evaporator 7 until the refrigerant turns into gas-phase refrigerant having a degree of superheat.

The pressure reducer 6 is disposed on a refrigerant outlet side of the receiver 5. The pressure reducer 6 is formed by what is called a fixed throttle and reduces the pressure of the refrigerant after passage through the condenser 4 and the receiver 5. The pressure reducer 6 functions as a pressure reducer in the present disclosure.

Although the fixed throttle is used as the pressure reducer 6 in the present disclosure, the pressure reducer 6 is not restricted to the fixed throttle. Various structures can be used as the pressure reducer if the pressure reducer can reduce the pressure of the refrigerant flowing out of the condenser 4. For example, a capillary tube may be employed as the pressure reducer in the present disclosure or an expansion valve with throttle opening controllable by control signals from the air-conditioning controller (not shown) may be used.

A refrigerant inlet of the evaporator 7 is connected to an outlet of the pressure reducer 6. The evaporator 7 is a heat exchanger that causes the refrigerant flowing out of the pressure reducer 6 and the blown air to exchange heat with each other and cools the blown air by means of the heat exchange with the refrigerant. In other words, the evaporator 7 operates as a cooling heat exchanger and functions as a heat absorber.

The gas-liquid separator 8 is connected to a refrigerant outlet of the evaporator 7. The gas-liquid separator 8 separates the refrigerant flowing in from the evaporator 7 into gas and liquid and stores excess liquid-phase refrigerant in the refrigeration cycle 2. The suction pipe 3C of the compressor 3 is connected to a gas-phase refrigerant outlet of the gas-liquid separator 8. Therefore, the gas-phase refrigerant separated in the gas-liquid separator 8 is drawn into the compressor 3 through the suction pipe 3C.

As shown in FIG. 3, a high pressure sensor 9 is disposed in a refrigerant pipe connecting the refrigerant outlet of the condenser 4 and the receiver 5. The high pressure sensor 9 detects a pressure of the refrigerant on the outlet side of the condenser 4 (i.e., a refrigerant pressure on a high-pressure side in the refrigeration cycle 2). Because the high pressure sensor 9 is connected to the air-conditioning controller (not shown), the air-conditioning controller can control air-conditioning operation of the seat air-conditioning device 1 in accordance with results of detection by the high pressure sensor 9.

An inside of the housing 10 of the seat air-conditioning device 1 is partitioned into a warm air flow path 11 and a cold air flow path 15. As shown in FIG. 3, the warm air flow path 11 is disposed at a left portion of the inside of the housing 10 and formed to extend in a front-rear direction. On the other hand, the cold air flow path 15 is disposed at a right portion of the inside of the housing 10 and formed to extend in the front-rear direction similarly to the warm air flow path 11.

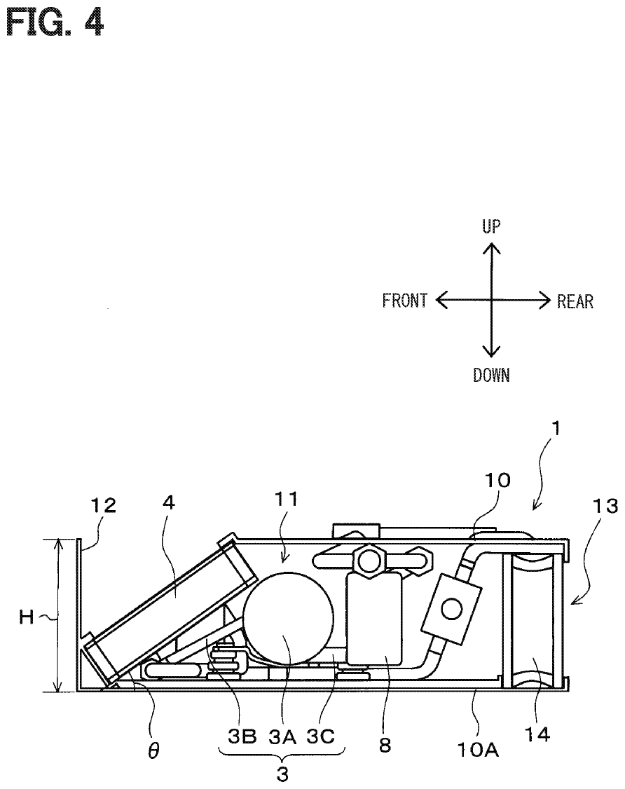

As shown in FIGS. 3 and 4, the warm-air-side intake port 12 is located at a left front portion of the upper face of the housing 10. The warm-air-side intake port 12 is an intake port which is formed to connect an inside of the warm air flow path 11 and the outside of the housing 10 and into which the blown air for flowing through the warm air flow path 11 is drawn.

A warm air blow outlet 13 is disposed at a left portion of a rear face of the housing 10. As shown in FIG. 4, the warm air blow outlet 13 is formed to connect the inside of the warm air flow path 11 and an outside space behind the housing 10 and functions as a blow outlet through which the blown air after passing through the warm air flow path 11 is blown out of the housing 10.

In the warm air flow path 11, the warm air blower 14 is mounted to the warm air blow outlet 13. The warm air blower 14 is an axial flow blower including an impeller having a plurality of blades and an electric motor that rotates the impeller, draws in air from one side in an axial direction along a drive shaft of the electric motor, and blows the air to the other side in the axial direction.

The warm air blower 14 is mounted to the warm air blow outlet 13 with the drive shaft of the electric motor oriented in the front-rear direction. Therefore, the warm air blower 14 blows the air in the warm air flow path 11 out of the housing 10 through the warm air blow outlet 13 by rotating the impeller.

In other words, in the warm air flow path 11, the air flowing in from the warm-air-side intake port 12 located on the left front side of the housing 10 flows from a front side toward a rear side when the warm air blower 14 operates. At this time, the blown air passes through the condenser 4 disposed in the warm air flow path 11 and therefore is warmed as a result of the heat exchange with the refrigerant in the condenser 4.

The air blown into the warm air blower 14 is blown out behind the housing 10 through the warm air blow outlet 13. In other words, in a plan view in FIG. 3, the blown air (i.e., warm air WA) in the warm air flow path 11 flows from the front side toward the rear side. A direction of the flow of air in the warm air flow path 11 is an example of an air blowing direction in the warm air flow path 11 in the present disclosure.

The inverter 19 is disposed at a rear left portion in the warm air flow path 11. The inverter 19 is a power converter that converts DC power supplied from the battery mounted to the electric car into AC power and outputs the AC power.

To put it concretely, the inverter 19 converts the DC power from the battery into the AC power that can be used for the compressor 3, the warm air blower 14, and the cold air blower 18 in the seat air-conditioning device 1 and outputs the AC power. The inverter 19 generates heat in the power conversion from the DC power into the AC power. Therefore, the inverter 19 is an example of a heat generating device in the present disclosure.

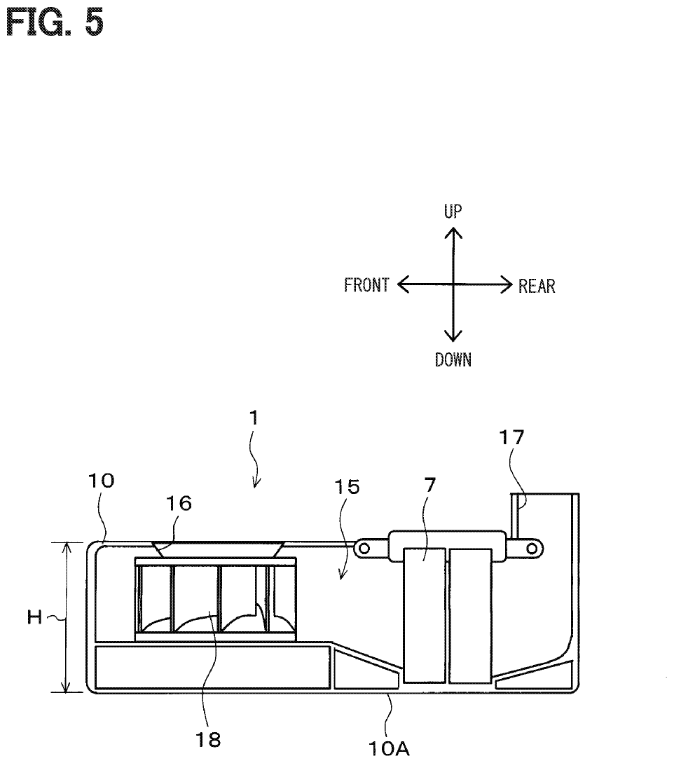

As shown in FIGS. 3 and 5, a cold-air-side intake port 16 is located at a right front portion of the upper face of the housing 10. The cold-air-side intake port 16 is an intake port which is formed to connect an inside of the cold air flow path 15 and the outside of the housing 10 and into which the blown air for flowing through the cold air flow path 15 is drawn.

A cold air blow outlet 17 is formed at a right rear portion of the upper face of the housing 10. As shown in FIG. 5, the cold air blow outlet 17 is formed in a shape of a rectangular cylinder extending upward and connects the inside of the cold air flow path 15 and the outside of the housing 10. Therefore, the cold air blow outlet 17 functions as a blow outlet through which the blown air after passing through the cold air flow path 15 is blown out of the housing 10.

The cold air blow outlet 17 is connected to a conditioned air supply portion (not shown) disposed in the seat 30. The blown air blown out of the cold air blow outlet 17 flows into blowing ducts such as the main ducts 21 shown in FIGS. 1 and 2 via the conditioned air supply portion and is supplied to the occupant sitting in the seat 30.

As shown in FIGS. 3 and 5, in the cold air flow path 15, the cold air blower 18 is disposed below the cold-air-side intake port 16. The cold air blower 18 is an electric blower including a centrifugal multi-blade fan driven by an electric motor. The cold air blower 18 is disposed with a rotating shaft of the centrifugal multi-blade fan oriented in a vertical direction of the housing 10.

Therefore, the cold air blower 18 draws in air in the vertical direction of the housing 10 and blows the drawn air in a centrifugal direction orthogonal to the shaft. Rotation speed (a blown air volume) of the centrifugal multi-blade fan in the cold air blower 18 is controlled by a control voltage output from the air-conditioning controller (described later).

In other words, the air around the cold-air-side intake port 16, located on the right front side of the housing 10, is drawn into the cold air blower 18 through the cold-air-side intake port 16 and flows into the cold air flow path 15 as a result of operation of the cold air blower 18. The air drawn into the cold air blower 18 flows toward a rear side of the housing 10 along the cold air flow path 15.

In other words, in the plan view in FIG. 3, the blown air (i.e., cold air CA) in the cold air flow path 15 flows from the front side toward the rear side. A direction of the flow of air in the cold air flow path 15 is an example of an air blowing direction in the cold air flow path according to the present disclosure. Because the blown air passes through the evaporator 7 disposed in the cold air flow path 15 while flowing rearward through the cold air flow path 15, the blown air is cooled due to the heat exchange with the refrigerant in the evaporator 7.

The blown air cooled by the evaporator 7 passes through the cold air blow outlet 17 and flows into the conditioned air supply portion (not shown). In other words, the cooled blown air (i.e., the cold air CA) flows into the blowing ducts such as the main ducts 21 shown in FIGS. 1 and 2 via the conditioned air supply portion and is supplied to the occupant sitting in the seat 30.

Next, a disposition of the blowing ducts that are flow paths for the blown air supplied from the housing 10 in the seat air-conditioning device 1 according to the first embodiment will be described. As shown in FIGS. 1 and 2, the plurality of blowing ducts is disposed on opposite side faces of the seat 30. The blowing ducts include the pair of main ducts 21, a pair of leg ducts 23, and a pair of upper ducts 25.

The main ducts 21 are formed in flat hollow shapes and respectively disposed on left and right opposite sides of the seat 30. Each of the main ducts 21 extends from the conditioned air supply portion disposed in the seat face 31 of the seat 30 to a height of a middle portion of the backrest 32 along the side face of the seat 30.

One end of each of the main ducts 21 is positioned at the same height as the middle portion of the backrest 32 and has a main blow outlet 22. The main blow outlet 22 communicates with an inside of the main duct 21 and curves slightly inward in a width direction of the seat 30. The other end of each of the main ducts 21 is connected to the cold air blow outlet 17 with the above-described conditioned air supply portion interposed therebetween.

Therefore, the cold air as the conditioned air conditioned by the seat air-conditioning device 1 is supplied to the occupant sitting in the seat 30 through the main blow outlets 22. Because the main blow outlets 22 curve slightly inward in the width direction at the height of the middle portion of the backrest 32, the seat air-conditioning device 1 can more efficiently supply the conditioned air to a trunk of the occupant sitting in the seat 30.

The leg ducts 23 are formed in hollow shapes and respectively disposed on left and right opposite sides of the seat face 31 of the seat 30. Each of the leg ducts 23 extends along a side face of the seat face 31 and then curves upward.

One end of each of the leg ducts 23 is positioned slightly above the upper face of the seat face 31 and has a leg blow outlet 24. The leg blow outlet 24 is formed to curve slightly inward in a vehicle width direction. On the other hand, the other end of each of the leg ducts 23 is connected to the cold air blow outlet 17 with the above-described conditioned air supply portion interposed therebetween.

Therefore, the cold air conditioned by the seat air-conditioning device 1 is supplied to the legs of the occupant sitting in the seat 30 through the leg blow outlets 24. Because the leg blow outlets 24 curve slightly inward in the vehicle width direction at positions slightly above the upper face of the seat face 31, the seat air-conditioning device 1 can more efficiently supply the conditioned air to the legs such as thighs of the occupant sitting in the seat 30.

The upper ducts 25 are formed in hollow shapes and respectively disposed on left and right opposite sides of the backrest 32. Each of the upper ducts 25 extends upward along a side face of the backrest 32 and bends forward at an upper portion of the backrest 32.

One end of each of the upper ducts 25 is positioned at the upper portion of the backrest 32 and has an upper blow outlet 26 open forward. The other end of each of the upper ducts 25 is connected to the cold air blow outlet 17 with the above-described conditioned air supply portion interposed therebetween. Therefore, the cold air conditioned by the seat air-conditioning device 1 is supplied to a space around the head of the occupant sitting in the seat 30 through the upper blow outlets 26.

The seat air-conditioning device 1 includes the air-conditioning controller for controlling operation of the component devices of the seat air-conditioning device 1. The air-conditioning controller is formed by a known microcomputer including a CPU, a ROM, RAM, and the like and peripheral circuits of the microcomputer. The air-conditioning controller performs various kinds of computing processing based on control programs stored in the ROM and controls operation of the compressor 3, the warm air blower 14, and the cold air blower 18.

The compressor 3, the warm air blower 14, and the cold air blower 18 are connected to an output side of the air-conditioning controller. Therefore, the air-conditioning controller can adjust refrigerant discharge performance (e.g., a refrigerant pressure) of the compressor 3 and blowing performance (e.g., blown air volumes) of the warm air blower 14 and the cold air blower 18 depending on situations.

The high pressure sensor 9 is connected to an input side of the air-conditioning controller. Therefore, the air-conditioning controller can adjust operation of the seat air-conditioning device 1 according to the refrigerant pressure on the high-pressure side of the refrigeration cycle 2 detected by the high pressure sensor 9. A group of other sensors for air-conditioning control such as an inside air temperature sensor and an outside air temperature sensor may be connected and an operation panel for giving directions about operation of the seat air-conditioning device 1 may be connected to the input side of the air-conditioning controller.

Next, an internal structure of the warm air flow path 11 in the seat air-conditioning device 1 will be described in detail with reference to FIGS. 3 and 4. As described above, the warm-air-side intake port 12 is formed in the upper face of the housing 10 on the front side of the warm air flow path 11. As a result, the air above the housing 10 is drawn into the warm air flow path 11. In other words, it is possible to suppress inflow of particles and dust into the warm air flow path 11 to thereby suppress malfunctions of the seat air-conditioning device 1 caused by the particles and the like.

The condenser 4 is disposed in the warm air flow path 11 below the warm-air-side intake port 12. As shown in FIGS. 3 and 4, the condenser 4 is formed in a plate shape and warms the blown air flowing through the warm air flow path 11 by means of the heat exchange with the refrigerant circulating through the refrigeration cycle 2.

As described above, in the warm air flow path 11, the flow of blown air from the warm-air-side intake port 12 toward the warm air blow outlet 13 is produced by the operation of the warm air blower 14. In other words, because the condenser 4 is disposed on an upstream side in the air blowing direction in the warm air flow path 11, the condenser 4 can perform the heat exchange with the blown air, which is less affected by heat generation by the component devices of the seat air-conditioning device 1, at the position close to the outside of the housing 10.

In other words, according to the seat air-conditioning device 1, the condenser 4 can perform the heat exchange while securing a sufficient difference in temperature between the refrigerant in the condenser 4 and the blown air flowing in from the warm-air-side intake port 12, which enhances heat exchange performance of the condenser 4.

As shown in FIGS. 3 and 4, the condenser 4 is disposed while being inclined at an inclination angle θ with respect to a housing bottom face 10A forming a lower face of the warm air flow path 11. The condenser 4 is disposed so that its portion closer to a downstream side (i.e. rear side) of the warm air flow path 11 in the air blowing direction is at a higher position in a height direction vertical to the housing bottom face 10A. The inclination angle θ is determined so that a height to a top portion of the condenser 4 is smaller than the housing height H in the direction vertical to the housing bottom face 10A.

Therefore, according to the seat air-conditioning device 1, it is possible to dispose the condenser 4, having a greater height than the housing height H of the housing 10 disposed in a limited space, in the warm air flow path 11 in the housing 10. Moreover, it is possible to secure a larger area of the condenser 4 through which the blown air passes in the warm air flow path 11 than when the condenser 4 is disposed perpendicularly to the housing bottom face 10A and therefore it is possible to maintain performance of the refrigeration cycle 2 in the seat air-conditioning device 1.

In the warm air flow path 11, the compressor 3 is disposed on a downstream side of the condenser 4 in the air blowing direction. Here, the blown air after passing through the condenser 4 is at a lower temperature than a temperature of the compressor 3 during the operation. Therefore, according to the seat air-conditioning device 1, the blown air after passing through the condenser 4 can cool the compressor 3 to thereby prevent overheating of the compressor 3.

At this time, the blown air flowing through the warm air flow path 11 is warmed by heat generation due to the operation of the compressor 3, which increases the temperature of the blown air blown out of the warm air flow path 11. In other words, by disposing the compressor 3 in the seat air-conditioning device 1 as described above, it is possible to enhance heating performance of the seat air-conditioning device 1.

As shown in FIGS. 3 and 4, because the condenser 4 is disposed while being inclined at the inclination angle θ with respect to the housing bottom face 10A, the portion of the condenser 4 on the upper side is disposed above the compressor 3. In other words, it is possible to effectively use the space saved by inclining the condenser 4 with respect to the housing bottom face 10A, which contributes to miniaturization of the housing 10. In other words, according to the seat air-conditioning device 1, it is possible to make the housing 10 easier to mount below the seat face 31.

In the compressor 3, the discharge pipe 3B is positioned on an upstream side of the main body 3A in the air blowing direction and disposed so that the blown air after passing through the condenser 4 is directly blown to the discharge pipe 3B. On the other hand, the suction pipe 3C is disposed on the housing bottom face 10A on a downstream side of the main body 3A in the air blowing direction. Therefore, the blown air after passing through the condenser 4 flows while detouring around the main body 3A and is not directly blown to the suction pipe 3C. In other words, the main body 3A of the compressor 3 also functions as an air guide member in the present disclosure.

Here, the blown air after passing through the condenser 4 is at the lower temperature than a temperature of the discharge pipe 3B and the higher temperature than a temperature of the suction pipe 3C of the compressor 3. Therefore, in the seat air-conditioning device 1, the blown air can cool the discharge pipe 3B that is at a high temperature and suppress heating of the suction pipe 3C that is at a low temperature in the compressor 3.

In other words, according to the seat air-conditioning device 1, it is possible to reduce the refrigerant pressure on the high-pressure side in the refrigeration cycle 2 to thereby suppress increase in a refrigerant pressure and an excessive degree of superheat on a low-pressure side in the refrigeration cycle 2. In this way, it is possible to enhance the performance of the refrigeration cycle 2.

As shown in FIGS. 3 and 4, the gas-liquid separator 8 is disposed on the downstream side of the condenser 4 and the compressor 3 and on an upstream side of the warm air blower 14 in the air blowing direction in the warm air flow path 11. The gas-liquid separator 8 is disposed on the rear side in the warm air flow path 11 and therefore can be disposed at a short distance from the evaporator 7 disposed on a rear side in the cold air flow path 15.

As a result, by disposing the gas-liquid separator 8 in this manner, it is possible to shorten a length of a refrigerant pipe for connection to the evaporator 7 and a length of the suction pipe 3C for connection to the compressor 3 to thereby achieve a more compact structure of the seat air-conditioning device 1.

As described above, the gas-liquid separator 8 is disposed on the downstream side of the compressor 3 in the air blowing direction in the warm air flow path 11. In other words, the main body 3A of the compressor 3 is positioned on an upstream side of the gas-liquid separator 8. Therefore, the blown air after passing through the condenser 4 flows while detouring around the main body 3A and is not directly blown to the gas-liquid separator 8. In other words, the main body 3A of the compressor 3 also functions as a guide member in the present disclosure.

Here, the blown air after passing through the condenser 4 is at the higher temperature than the gas-liquid separator 8. Therefore, with such a disposition that the blown air after passing through the condenser 4 is directly blown to the gas-liquid separator 8, the blown air may warm the refrigerant flowing through the gas-liquid separator 8 to increase the refrigerant pressure on the low-pressure side in the refrigeration cycle 2, which may cause a decrease in the performance of the refrigeration cycle 2.

In this respect, the blown air after passing through the condenser 4 flows while detouring around the main body 3A of the compressor 3 and therefore is not directly blown to the gas-liquid separator 8. In other words, according to the seat air-conditioning device 1, it is possible to suppress the increase in the refrigerant pressure on the low-pressure side due to an increase in a temperature of the gas-liquid separator 8 to thereby suppress the decrease in the performance of the refrigeration cycle 2 caused by the pressure increase.

In a rear portion that is the most downstream portion of the warm air flow path 11, the warm air blow outlet 13 is formed and the warm air blower 14 is mounted. As described above, the warm air blower 14 operates to thereby produce the flow of blown air from the warm-air-side intake port 12 toward the warm air blow outlet 13. At this time, heat is generated by the operation of the warm air blower 14 and an influence of the heat generation needs to be considered.

As shown in FIGS. 3 and 4, because the warm air blower 14 is disposed at the most downstream portion in the warm air flow path 11 in the air blowing direction, the heat generation due to the operation of the warm air blower 14 can be used to heat the blown air (i.e., the warm air) warmed by the condenser 4. Moreover, because the blown air warmed by the heat generation by the warm air blower 14 is blown out of the housing 10 through the warm air blow outlet 13, it is possible to suppress the influence on the other components in the housing 10 in the seat air-conditioning device 1.

At the rear portion that is the most downstream portion of the warm air flow path 11, the inverter 19 is disposed next to the warm air blower 14. The inverter 19 generates the heat in the power conversion from the DC power into the AC power. In other words, the inverter 19 functions as the example of the heat generating device in the present disclosure.

Similarly to the warm air blower 14, because the inverter 19 is disposed at the most downstream portion in the warm air flow path 11 in the air blowing direction, the heat generation due to application of the power to the inverter 19 can be used to heat the blown air (i.e., the warm air) warmed by the condenser 4. Moreover, because the blown air warmed by the heat generation by the inverter 19 is blown out of the housing 10 through the warm air blow outlet 13, it is possible to suppress an influence on the other components in the housing 10 to thereby suppress the decrease in the performance of the refrigeration cycle 2 in the seat air-conditioning device 1.

Next, an internal structure of the cold air flow path 15 in the seat air-conditioning device 1 will be described in detail with reference to FIGS. 3 and 5. The cold-air-side intake port 16 is formed in the upper face of the housing 10 on a front side of the cold air flow path 15. As a result, the air above the housing 10 is drawn into the cold air flow path 15. In other words, it is possible to suppress inflow of particles and dust into the cold air flow path 15 to thereby suppress the malfunctions of the seat air-conditioning device 1 caused by the particles and the like.

In the cold air flow path 15 below the cold-air-side intake port 16, the cold air blower 18 is disposed. In other words, the cold air blower 18 is disposed on an upstream side in the air blowing direction in the cold air flow path 15. The cold air blower 18 operates to thereby produce the flow of blown air from the cold-air-side intake port 16 toward the cold air blow outlet 17.

The cold air blower 18 is disposed on the upstream side in the air blowing direction in the cold air flow path 15 and the evaporator 7 is disposed on a downstream side of the cold air flow path 15. In other words, heat generated by the operation of the cold air blower 18 acts on the blown air before the heat exchange in the evaporator 7.

As shown in FIGS. 3 and 5, the evaporator 7 is disposed on the downstream side of the cold air blower 18 in the air blowing direction in the cold air flow path 15. The evaporator 7 according to the first embodiment is disposed at a downstream portion in the cold air flow path 15 in the air blowing direction and formed in a plate shape. The evaporator 7 is disposed to be perpendicular to the housing bottom face 10A forming a lower face of the cold air flow path 15 and can cool the blown air flowing through the cold air flow path 15 by means of the heat exchange with the refrigerant circulating through the refrigeration cycle 2.

The cold air blow outlet 17 is formed at the right rear portion of the upper face of the housing 10. As shown in FIG. 5, the cold air blow outlet 17 is formed in a shape of a rectangular cylinder extending upward and connects the inside of the cold air flow path 15 and the outside of the housing 10. The evaporator 7 is disposed on the downstream side in the cold air flow path 15 and on the upstream side of the cold air blow outlet 17 in the air blowing direction.

Therefore, in the seat air-conditioning device 1, the blown air after passing through the evaporator 7 is blown out of the housing 10 (i.e., to the conditioned air supply portion) through the cold air blow outlet 17. In this way, the seat air-conditioning device 1 is formed to swiftly blow the cold air cooled by the evaporator 7 out of the housing 10 to thereby supply comfortable cold air while suppressing an increase in the temperature due to the heat generated in the housing 10.

By disposing the condenser 4 on the upstream side in the air blowing direction in the warm air flow path 11 and disposing the evaporator 7 on the downstream side in the air blowing direction in the cold air flow path 15, it is possible to dispose the condenser 4 on the left front side and the evaporator 7 on the right rear side in the rectangular parallelepiped housing 10.

By disposing the warm air blower 14 on the downstream side in the air blowing direction in the warm air flow path 11 and disposing the cold air blower 18 on the upstream side in the air blowing direction in the cold air flow path 15, it is possible to dispose the warm air blower 14 on a left rear side and the cold air blower 18 on the right front side in the housing 10.

In other words, as shown in FIG. 3, according to the seat air-conditioning device 1, it is possible to dispose the respective component devices so that an imaginary line LA connecting the condenser 4 and the evaporator 7 intersects an imaginary line LB connecting the warm air blower 14 and the cold air blower 18 in the housing 10.

Here, one end of the imaginary line LA is positioned at a center of a heat exchanging portion of the condenser 4 formed in the plate shape and the other end of the imaginary line LA is positioned at a center of a heat exchanging portion of the evaporator 7 formed in the plate shape. One end of the imaginary line LB is positioned on a rotating shaft of the impeller of the warm air blower 14 and the other end of the imaginary line LB is positioned on the rotating shaft of the centrifugal multi-blade fan of the cold air blower 18.

Positions of the ends of the imaginary lines LA, LB are not restricted to these examples and can be changed in various ways. For example, the one end of the imaginary line LA may be at a farthest position of the condenser 4 from the evaporator 7 and the other end of the imaginary line LA may be at a farthest position of the evaporator 7 from the condenser 4.

With this disposition, in the seat air-conditioning device 1, it is possible to put a largest possible distance between the condenser 4 and the evaporator 7 in the rectangular parallelepiped housing 10. In other words, according to the seat air-conditioning device 1, it is possible to suppress mutual influences of heat dissipation by the condenser 4 in the warm air flow path 11 and heat absorption by the evaporator 7 in the cold air flow path 15 on each other in the housing 10 disposed in the small space to thereby suppress the decrease in the performance of the refrigeration cycle 2.

According to the seat air-conditioning device 1, it is possible to put a large distance between the warm air blower 14 and the cold air blower 18 in the rectangular parallelepiped housing 10. In other words, according to the seat air-conditioning device 1, it is possible to suppress the influences of the heat generation by the warm air blower 14 and the heat generation by the cold air blower 18 to thereby suppress the decrease in the performance of the refrigeration cycle 2 due to the influences of the heat.

As described above, the seat air-conditioning device 1 according to the first embodiment can supply the conditioned air such as the warm air after the passage through the warm air flow path 11 and the cold air after the passage through the cold air flow path 15 to the seat 30 by putting the refrigeration cycle 2, the warm air blower 14, and the cold air blower 18 disposed in the housing 10 into operation. In other words, the seat air-conditioning device 1 can increase the comfort of the occupant sitting in the seat 30 with the conditioned air from the housing 10.

As shown in FIG. 3, in the housing 10 of the seat air-conditioning device 1, the condenser 4, the evaporator 7, the warm air blower 14, and the cold air blower 18 are disposed so that the imaginary line LA connecting the condenser 4 and the evaporator 7 intersects the imaginary line LB connecting the warm air blower 14 and the cold air blower 18. To put it concretely, the warm air blower 14 is disposed on the downstream side in the air blowing direction in the warm air flow path 11 and the cold air blower 18 is disposed on the upstream side in the air blowing direction in the cold air flow path 15 extending along the warm air flow path 11.

In other words, according to the seat air-conditioning device 1, it is possible to put the large distance between the warm air blower 14 and the cold air blower 18 that generate heat when they operate in the housing 10 to thereby suppress the decrease in the performance of the refrigeration cycle 2 due to the heat generation of the warm air blower 14 and the cold air blower 18.

With this disposition, the condenser 4 is disposed on the upstream side in the air blowing direction in the warm air flow path 11 and the evaporator 7 is disposed on the downstream side in the air blowing direction in the cold air flow path 15. In other words, according to the seat air-conditioning device 1, it is possible to put the large distance between the condenser 4 that functions as the radiator and the evaporator 7 that functions as the heat absorber in the housing 10 and therefore it is possible to suppress the thermal influences of the condenser 4 and the evaporator 7 on each other to thereby suppress the decrease in the performance of the refrigeration cycle 2.

Moreover, because the condenser 4 is disposed on the upstream side in the air blowing direction and the warm air blower 14 is disposed on the downstream side in the air blowing direction in the warm air flow path 11, the blown air that has turned into the warm air as a result of the passage through the condenser 4 can be further warmed by the heat generation by the warm air blower 14.

On the other hand, because the cold air blower 18 is disposed on the upstream side in the air blowing direction and the evaporator 7 is disposed on the downstream side in the air blowing direction in the cold air flow path 15, the blown air that has turned into the cold air as a result of the passage through the evaporator 7 can be supplied from the cold air flow path 15 to the seat 30 without being influenced by the heat generation by the cold air blower 18 and the like. In other words, according to the seat air-conditioning device 1, it is possible to increase the comfort of the occupant sitting in the seat 30 while suppressing the decrease in the performance of the refrigeration cycle 2.

According to the seat air-conditioning device 1, because the compressor 3 is disposed on the downstream side of the condenser 4 in the air blowing direction in the warm air flow path 11 in the housing 10, it is possible to cool the compressor 3 with the blown air after the passage through the condenser 4 to thereby suppress the overheating of the compressor 3. Furthermore, it is possible to warm the blown air after the passage through the condenser 4 with the heat generated by the operation of the compressor 3 to thereby enhance the performance of the refrigeration cycle 2.

As shown in FIG. 3, the discharge pipe 3B corresponding to a discharge portion of the compressor 3 is positioned on the upstream side of the main body 3A in the air blowing direction and disposed so that the blown air after passing through the condenser 4 is directly blown to the discharge pipe 3B. On the other hand, the suction pipe 3C corresponding to a suction portion of the compressor 3 is disposed on the housing bottom face 10A on the downstream side of the main body 3A in the air blowing direction. Therefore, the blown air after passing through the condenser 4 flows while detouring around the main body 3A and is not directly blown to the suction pipe 3C.

Therefore, in the seat air-conditioning device 1, the blown air after passing through the condenser 4 can cool the discharge pipe 3B that is at the high temperature and suppress heating of the suction pipe 3C that is at the low temperature in the compressor 3. In other words, according to the seat air-conditioning device 1, it is possible to reduce the refrigerant pressure on the high-pressure side in the refrigeration cycle 2 to thereby suppress increase in a refrigerant pressure and an excessive degree of superheat on a low-pressure side in the refrigeration cycle 2. In this way, it is possible to enhance the performance of the refrigeration cycle 2.

In the seat air-conditioning device 1 according to the first embodiment, the condenser 4 is disposed while being inclined at the inclination angle θ with respect to the housing bottom face 10A of the housing 10 in the warm air flow path 11. Because the condenser 4 is disposed at the inclination angle θ, it is possible to dispose the evaporator 7 having the larger height dimension than the housing height H of the housing 10 in the housing 10 to thereby secure a heat exchange area in the condenser 4.

As shown in FIGS. 3 and 4, the condenser 4 is inclined so that its portion closer to the downstream side of the warm air flow path 11 in the air blowing direction is at the higher position and that its upper portion is positioned above a portion of the compressor 3.

As a result, according to the seat air-conditioning device 1, it is possible to dispose the compressor 3 on the downstream side in the air blowing direction while effectively using the space below the condenser 4 inclined with respect to the housing bottom face 10A. In other words, according to the seat air-conditioning device 1, with this disposition, it is possible to miniaturize the housing 10 to thereby make the housing 10 easier to mount into the limited space such as the space below the seat face 31.

The inclination angle θ of the condenser 4 is determined so that the height to the top portion of the condenser 4 is smaller than the housing height H of the housing 10. Therefore, it is possible to dispose the condenser 4 having the larger height dimension than the housing height H in the warm air flow path 11 in the housing 10 by inclining the condenser 4 at the inclination angle θ with respect to the housing bottom face 10A to thereby secure the heat exchange area in the condenser 4.

Because the gas-liquid separator 8 is disposed on the downstream side of the condenser 4 in the air blowing direction in the warm air flow path 11, the gas-liquid separator 8 can be disposed at the short distance from the evaporator 7 disposed on the downstream side in the air blowing direction in the cold air flow path 15. In other words, according to the seat air-conditioning device 1, it is possible to shorten the length of the refrigerant pipe connecting the gas-liquid separator 8 and the condenser 4 in the housing 10 to thereby make the housing 10 easier to mount.

In the warm air flow path 11, the gas-liquid separator 8 is disposed on the downstream side of the main body 3A of the compressor 3 in the air blowing direction. Therefore, the main body 3A functions as the guide member and, as a result, the blown air after passing through the condenser 4 flows while detouring around the main body 3A and is not directly blown to the gas-liquid separator 8.

In this way, according to the seat air-conditioning device 1, it is possible to suppress the increase in the temperature of the gas-liquid separator 8 caused by direct blowing of the blown air after the passage through the condenser 4 to the gas-liquid separator 8 to thereby suppress the increase in the refrigerant pressure on the low-pressure side due to the increase in the temperature of the gas-liquid separator 8. In other words, in the seat air-conditioning device 1, it is possible to suppress the decrease in the performance of the refrigeration cycle 2 caused by the increase in the refrigerant pressure on the low-pressure side.

The inverter 19 is disposed at the most downstream portion in the air blowing direction in the warm air flow path 11. The inverter 19 is an example of the heat generating device in the present disclosure and generates the heat in the power conversion from the DC power into the AC power. Therefore, according to the seat air-conditioning device 1, the heat generation due to the application of the power to the inverter 19 can be used to heat the blown air (i.e., the warm air WA) warmed by the condenser 4.

As shown in FIGS. 3 and 4, the warm-air-side intake port 12 is formed in the upper face of the housing 10 on the front side of the warm air flow path 11. Therefore, the air above the housing 10 is drawn into the warm air flow path 11 through the warm-air-side intake port 12. Because the air above the housing 10 includes fewer particles and less dust than air on a side of the vehicle interior floor F, in the seat air-conditioning device 1, it is possible to suppress the inflow of the particles and the dust into the warm air flow path 11 to thereby suppress the malfunctions of the seat air-conditioning device 1 caused by the particles and the like.

The cold-air-side intake port 16 is formed in the upper face of the housing 10 on the front side of the cold air flow path 15. Therefore, the air above the housing 10 flows into the cold air flow path 15 through the cold-air-side intake port 16. Because the air above the housing 10 includes the fewer particles and the less dust than the air on the side of the vehicle interior floor F, in the seat air-conditioning device 1, it is possible to suppress the inflow of the particles and the dust into the cold air flow path 15 to thereby suppress the malfunctions of the seat air-conditioning device 1 caused by the particles and the like.

### Second Embodiment

Next, a second embodiment different from the above-described first embodiment will be described with reference to the drawings. A seat air-conditioning device 1 according to the second embodiment is applied to an electric car that travels by using power of a battery as in the first embodiment. In the following description, the same reference signs as those in the first embodiment designate the same components and the preceding description can be referred to.

The seat air-conditioning device 1 in the second embodiment is formed similarly to that in the above-described first embodiment except for an internal structure of a cold air flow path 15. In other words, the seat air-conditioning device 1 according to the second embodiment includes a vapor compression refrigeration cycle 2, a warm air blower 14, a cold air blower 18, and an inverter 19 housed in a housing 10.

Therefore, as in the first embodiment, the seat air-conditioning device 1 according to the second embodiment can adjust temperatures of air, blown by operation of the warm air blower 14 and the cold air blower 18, with the refrigeration cycle 2 and supply the air to an occupant sitting in a seat 30 through main ducts 21 and the like disposed on opposite sides of the seat 30.

In the seat air-conditioning device 1 according to the second embodiment, as in the first embodiment, a warm air flow path 11 is disposed on a left side in the housing 10 and the blown air is blown in an air blowing direction from a warm-air-side intake port 12 toward a warm air blow outlet 13 by the operation of the warm air blower 14.

In the warm air flow path 11, as in the first embodiment, the condenser 4, a compressor 3, a gas-liquid separator 8, the warm air blower 14, and an inverter 19 are arranged in this order from an upstream side toward a downstream side in the air blowing direction. These structures are similar to those in the first embodiment and will not be described again.

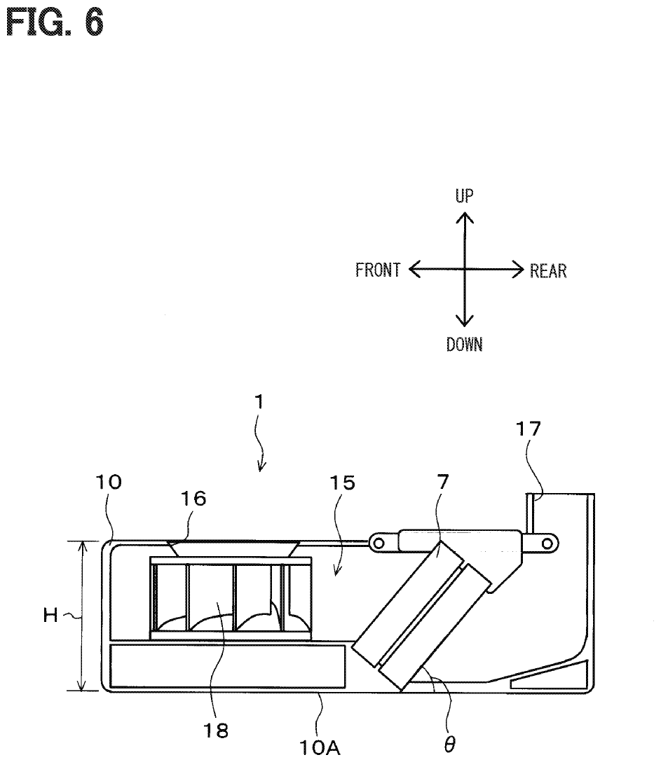

The internal structure of the cold air flow path 15 in the seat air-conditioning device 1 according to the second embodiment will be described in detail with reference to FIG. 6. FIG. 6 is a sectional view of the internal structure of the cold air flow path 15 in the seat air-conditioning device 1 according to the second embodiment and shows a section corresponding to the section along line V-V in the first embodiment.

As shown in FIG. 6, a cold-air-side intake port 16 is formed in an upper face of the housing 10 on a front side of the cold air flow path 15 in the second embodiment as well. As a result, the air above the housing 10 is drawn into the cold air flow path 15. According to the seat air-conditioning device 1, it is possible to suppress inflow of particles and dust into the cold air flow path 15 to thereby suppress malfunctions of the seat air-conditioning device 1 caused by the particles and the like.

In the cold air flow path 15 below the cold-air-side intake port 16, the cold air blower 18 is disposed. In other words, the cold air blower 18 is disposed on an upstream side in the air blowing direction in the cold air flow path 15. The cold air blower 18 is disposed on the upstream side in the air blowing direction in the cold air flow path 15 and the evaporator 7 is disposed on a downstream side of the cold air flow path 15. In other words, heat generated by the operation of the cold air blower 18 acts on the blown air before the heat exchange in the evaporator 7.

The evaporator 7 is disposed on the downstream side of the cold air blower 18 in the air blowing direction in the cold air flow path 15. The evaporator 7 can cool the blown air flowing through the cold air flow path 15 by means of the heat exchange with refrigerant circulating through the refrigeration cycle 2.

As shown in FIG. 6, the evaporator 7 according to the second embodiment is disposed while being inclined at an inclination angle θ with respect to a housing bottom face 10A. The inclination angle θ is determined so that a height to a top portion of the evaporator 7 is smaller than a housing height H in a direction vertical to the housing bottom face 10A.

Therefore, according to the seat air-conditioning device 1 according to the second embodiment, it is possible to dispose the evaporator 7, having a greater height than the housing height H of the housing 10 disposed in a limited space, in the cold air flow path 15 in the housing 10. Moreover, it is possible to secure a larger area of the evaporator 7 through which the blown air passes in the cold air flow path 15 than when the evaporator 7 is disposed perpendicularly to the housing bottom face 10A and therefore it is possible to maintain performance of the refrigeration cycle 2 in the seat air-conditioning device 1.

In the evaporator 7, condensed water may be generated in some cases due to heat exchange with the blown air flowing through the cold air flow path 15. If the condensed water is generated in the evaporator 7, the condensed water creates a ventilation resistance when the blown air passes through the evaporator 7 to thereby decrease heat exchange performance of the evaporator 7.

The evaporator 7 according to the second embodiment is disposed while being inclined with respect to the housing bottom face 10A so that its portion closer to a downstream side of the cold air flow path 15 in the air blowing direction is at a higher position. Therefore, the force of gravity due to the inclination angle θ and a force of the blown air passing through the evaporator 7 act on the condensed water in the evaporator 7. In this way, in the seat air-conditioning device 1 according to the second embodiment, it is possible to enhance condensed water drainage performance of the evaporator 7 to thereby suppress increase in the ventilation resistance in the evaporator 7 due to the condensed water.

A cold air blow outlet 17 is formed at a right rear portion of the upper face of the housing 10 in the second embodiment as well. As shown in FIG. 6, the cold air blow outlet 17 is formed in a shape of a rectangular cylinder extending upward and connects an inside of the cold air flow path 15 and an outside of the housing 10.

Therefore, the blown air after passing through the evaporator 7 is blown out of the housing 10 (i.e., to a conditioned air supply portion) through the cold air blow outlet 17 in the second embodiment as well. In this way, the seat air-conditioning device 1 can swiftly blow the cold air cooled by the evaporator 7 out of the housing 10 to thereby supply comfortable cold air while suppressing an increase in a temperature due to heat generated in the housing 10.

As described above, the seat air-conditioning device 1 according to the second embodiment can exert similar effects to those of the above-described first embodiment. In the second embodiment, the evaporator 7 is disposed while being inclined at the inclination angle θ with respect to the housing bottom face 10A in the cold air flow path 15. The inclination angle θ is determined so that the height to the top portion of the evaporator 7 is smaller than the housing height H in the direction vertical to the housing bottom face 10A.

Therefore, according to the seat air-conditioning device 1 in the second embodiment, it is possible to dispose the evaporator 7 having a larger height dimension than the housing height H in the cold air flow path 15 in the housing 10 by inclining the evaporator 7 at the inclination angle θ with respect to the housing bottom face 10A. Moreover, it is possible to secure a larger area of the evaporator 7 through which the blown air passes in the cold air flow path 15 than when the evaporator 7 is disposed perpendicularly to the housing bottom face 10A and therefore it is possible to maintain performance of the refrigeration cycle 2 in the seat air-conditioning device 1.

The evaporator 7 according to the second embodiment is disposed while being inclined with respect to the housing bottom face 10A so that its portion closer to the downstream side of the cold air flow path 15 in the air blowing direction is at the higher position. Therefore, the force of gravity due to the inclination angle θ and a force of the blown air passing through the evaporator 7 act on the condensed water in the evaporator 7. In this way, in the seat air-conditioning device 1 according to the second embodiment, it is possible to enhance the condensed water drainage performance of the evaporator 7 and at the same time it is possible to suppress the increase in the ventilation resistance in the evaporator 7.

### Third Embodiment

Next, a third embodiment different from the above-described respective embodiments will be described with reference to the drawings. A seat air-conditioning device 1 according to the third embodiment is applied to an electric car that travels by using power of a battery as in the above-described embodiments. In the following description, the same reference signs as those in the above-described embodiments designate the same components and the preceding description can be referred to.

The seat air-conditioning device 1 in the third embodiment is formed similarly to that in each of the above-described embodiments except for a structure of a warm air flow path 11 and a manner of operation of a warm air blower 14. In other words, the seat air-conditioning device 1 according to the third embodiment includes a vapor compression refrigeration cycle 2, a warm air blower 14, a cold air blower 18, and an inverter 19 housed in a housing 10.

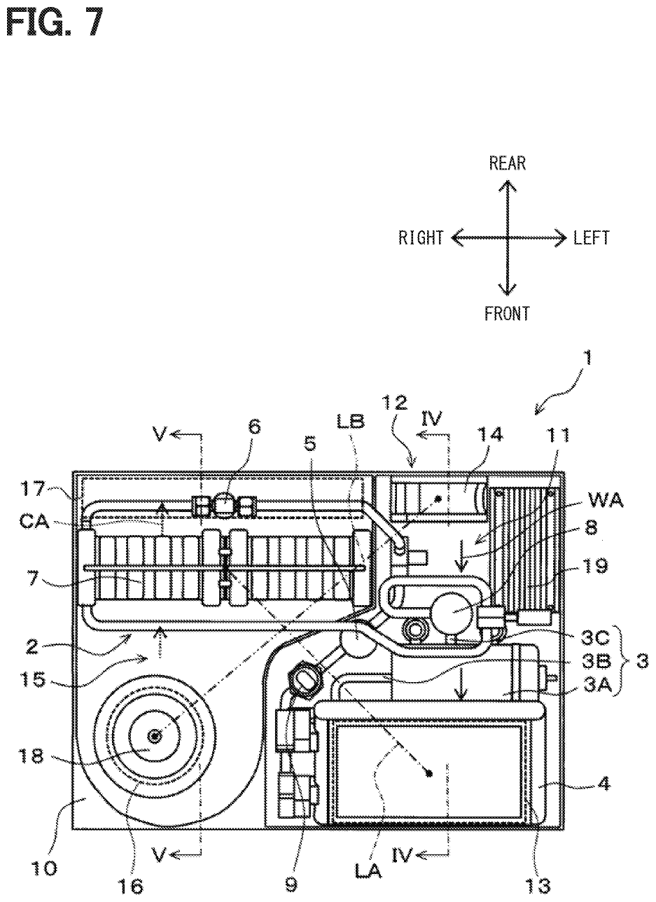

As shown in FIG. 7, in a cold air flow path 15 according to the third embodiment, a cold-air-side intake port 16 is located at a right front portion of an upper face of the housing 10 as in the above-described embodiments. A cold air blow outlet 17 is located at a right rear portion of the upper face of the housing 10.

In the cold air flow path 15, the cold air blower 18 is disposed below the cold-air-side intake port 16 and an evaporator 7 is disposed behind the cold air blower 18. Therefore, as in the above-described embodiments, cold air CA flows from a front side toward a rear side in the cold air flow path 15.

In a warm air flow path 11 according to the third embodiment, a warm-air-side intake port 12 is disposed at a left portion of a rear face of the housing 10. A warm air blow outlet 13 according to the third embodiment is located at a left front portion of the upper face of the housing 10.

As shown in FIG. 7, in the warm air flow path 11 in the third embodiment, a condenser 4 is disposed below the warm air blow outlet 13 and the warm air blower 14 is mounted to the warm-air-side intake port 12 behind the condenser 4.

The warm air blower 14 in the third embodiment is disposed to draw in air outside the housing 10 through the warm-air-side intake port 12 and blow the air into the warm air flow path 11. As shown in FIG. 7, the blown air blown from the warm air blower 14 passes through the condenser 4 and the warm air blow outlet 13 and is then blown as warm air WA out of the housing 10 through the warm air blow outlet 13.

In other words, in the third embodiment, a direction of a flow of the warm air WA in the warm air flow path 11 and a direction of a flow of the cold air CA in the cold air flow path 15 are opposite. As shown in FIG. 7, an imaginary line LA connecting the condenser 4 and the evaporator 7 intersects an imaginary line LB connecting the warm air blower 14 and the cold air blower 18 in this case as well.

Therefore, in the seat air-conditioning device 1 according to the third embodiment, it is possible to put the largest possible distances between the condenser 4 and the evaporator 7 and between the warm air blower 14 and the cold air blower 18 in the housing 10 and therefore it is possible to suppress thermal influences of the condenser 4, the evaporator 7, the warm air blower 14, and the cold air blower 18 to thereby suppress a decrease in the performance of the refrigeration cycle 2.

As described above, the seat air-conditioning device 1 according to the third embodiment can exert similar effects to those of the above-described respective embodiments, though the direction of the flow of the blown air (i.e., the warm air WA) in the warm air flow path 11 and the direction of the flow of the blown air (i.e., the cold air CA) in the cold air flow path 15 are opposite.

Although the warm air WA flows from a rear side toward a front side in the warm air flow path 11 and the cold air CA flows from the front side toward the rear side in the cold air flow path 15 in the third embodiment, the present disclosure is not restricted to these directions.

In other words, the warm air WA may flow from the front side toward the rear side in the warm air flow path 11 and the cold air CA may flow from the rear side toward the front side in the cold air flow path 15. Similar effects to those of the third embodiment are exerted in this case as well.

### OTHER EMBODIMENTS

Although the present disclose has been described above based on the embodiments, the present disclosure is not restricted to the above-described embodiments at all. In other words, various modifications can be made without departing from the gist of the present disclosure. For example, the above-described respective embodiments may be combined with each other if necessary. The above-described embodiments can be modified in the following various ways, for example.

(1) Although the warm air passing through the warm air blow outlet 13 is blown out behind the housing 10 in the above-described embodiments, the present disclosure is not restricted to this structure. For example, it is possible to make such a connection as to supply warm air blown out of a warm air blow outlet 13 to a conditioned air supply portion to thereby supply the warm air to an occupant sitting in a seat 30 through blowing ducts such as main ducts 21.

It is possible to form a structure that can switch blown air supplied to main ducts 21 and the like between warm air blown out of a warm air blow outlet 13 and cold air blown out of a cold air blow outlet 17. With this structure, it is possible to selectively perform heating operation and cooling operation to thereby increase comfort of an occupant sitting in a seat 30.

(2) Although the housing 10 of the seat air-conditioning device 1 is formed in such a rectangular parallelepiped shape that the housing 10 can be disposed between the seat face 31 of the seat 30 and the vehicle interior floor F in each of the above-described embodiments, the housing 10 is not restricted to this shape. A shape of a housing in a seat air-conditioning device according to the present disclosure only needs to be such a three-dimensional shape that the housing can be disposed between a seat face 31 of a seat 30 and a vehicle interior floor F. For example, the housing may be formed in a circular columnar shape or a prism shape having a hexagonal base or an octagonal base.

(3) Although the housing 10 of the seat air-conditioning device 1 is disposed between the seat face 31 of the seat 30 and the vehicle interior floor F in each of the above-described embodiments, a place where the housing 10 is mounted is not restricted to this place and various places may be employed. For example, a housing 10 may be disposed in a center console of an electric car or on a side face of a seat 30.

(4) Although the condenser 4 is disposed while being inclined at the inclination angle θ with respect to the housing bottom face 10A in each of the above-described embodiments, the present disclosure is not restricted to this structure. A condenser 4 can be disposed perpendicularly to a housing bottom face 10A in a warm air flow path 11.

(5) Although the inverter 19 is described as the heat generating device according to the present disclosure in each of the above-described embodiments, the present disclosure is not restricted to this structure. As the heat generating device according to the present disclosure, various devices can be employed, if the devices are component devices that are disposed on a downstream side of a condenser 4 in an air blowing direction in a warm air flow path 11 and generate heat when power is applied to the devices due to operation of a seat air-conditioning device.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A seat air-conditioning device for supplying conditioned air to a seat in a vehicle interior, the seat air-conditioning device comprising:
a housing;
a refrigeration cycle including a compressor configured to compress and discharge refrigerant, a condenser configured to cause the refrigerant discharged from the compressor to dissipate heat, a pressure reducer configured to reduce a pressure of the refrigerant flowing out of the condenser, and an evaporator configured to evaporate the refrigerant reduced in pressure in the pressure reducer, the refrigeration cycle being disposed in the housing;
a warm air flow path which extends in a predetermined direction in the housing and through which air warmed by the condenser flows;
a cold air flow path which extends side by side with the warm air flow path in the housing and through which air cooled by the evaporator flows;
a warm air blower that includes a first driving unit disposed in the warm air flow path and blows air in a first air-blowing direction by operation of the first driving unit in the warm air flow path; and
a cold air blower that includes a second driving unit disposed in the cold air flow path and blows air in a second air-blowing direction by operation of the second driving unit in the cold air flow path, wherein
the condenser is disposed in the warm air flow path, and the evaporator is disposed in the cold air flow path, and
a line connecting the condenser and the evaporator intersects a line connecting the warm air blower and the cold air blower in the housing.

2. The seat air-conditioning device according to claim 1, wherein
the condenser is disposed on an upstream side in the air blowing direction in the warm air flow path, and the warm air blower is disposed on a downstream side in the air blowing direction in the warm air flow path, and
the evaporator is disposed on a downstream side in the air blowing direction in the cold air flow path, and the cold air blower is disposed on an upstream side in the air blowing direction in the cold air flow path.

3. The seat air-conditioning device according to claim 1, wherein the compressor is disposed on a downstream side of the condenser in the air blowing direction in the warm air flow path.

4. The seat air-conditioning device according to claim 1, wherein
the compressor includes a suction portion into which the refrigerant flowing through the refrigeration cycle is drawn, a main body that compresses the refrigerant drawn in from the suction portion, and a discharge portion from which the refrigerant compressed in the main body is discharged, and
the warm air flow path has, on a downstream side of the condenser and an upstream side of the suction portion in the air blowing direction in the warm air flow path, an air guide member that guides the air flowing toward the suction portion to be detoured around the air guide member.

5. The seat air-conditioning device according to claim 1, wherein at least one of the condenser and the evaporator is inclined at a predetermined inclination angle with respect to a bottom face of the housing.

6. The seat air-conditioning device according to claim 1, wherein at least one of the condenser and the evaporator is inclined, and a portion of the one of the condenser or the evaporator closer to the downstream side in the air blowing direction is at a higher position in a height direction with respect to the bottom face of the housing.

7. The seat air-conditioning device according to claim 1, wherein
the condenser is inclined at a predetermined inclination angle, and a portion of the condenser closer to the downstream side in the air blowing direction is at the higher position in the height direction with respect to the bottom face of the housing, and
a portion of the condenser is positioned above a portion of the compressor disposed on the downstream side in the air blowing direction in the warm air flow path.

8. The seat air-conditioning device according to claim 5, wherein a height dimension of a top portion of at least one of the condenser and the evaporator is smaller than a height dimension of the housing.

9. The seat air-conditioning device according to claim 1, wherein
the refrigeration cycle includes a gas-liquid separator that is connected to the evaporator and the compressor, separates the refrigerant flowing out of the evaporator into gas and liquid, and causes the separated gas refrigerant to flow out to the compressor, and
the gas-liquid separator is disposed on a downstream side of the condenser in the air blowing direction in the warm air flow path.

10. The seat air-conditioning device according to claim 9, wherein
a guide member is provided in the warm air flow path on a downstream side of the condenser in the air blowing direction and an upstream side of the gas-liquid separator in the air blowing direction, to guide the air flowing toward the gas-liquid separator while detouring around the guide member.

11. The seat air-conditioning device according to claim 1, further comprising
a heat generating device configured to generate heat when power is applied to the heat generating device in accordance with operation of the seat air-conditioning device, wherein
the heat generating device is disposed on a downstream side of the condenser in the air blowing direction in the warm air flow path.

12. The seat air-conditioning device according to claim 1, wherein
the housing is disposed between a seat face of the seat and a vehicle interior floor, and
a warm-air-side intake port that connects an inside of the warm air flow path and an outside of the housing is located at an upper face of the housing.

13. The seat air-conditioning device according to claim 1, wherein
the housing is disposed between a seat face of the seat and the vehicle interior floor, and
a cold-air-side intake port that connects an inside of the cold air flow path and the outside of the housing is located at the upper face of the housing.

14. A seat air-conditioning device for supplying conditioned air to a seat in a vehicle interior, the seat air-conditioning device comprising:
a housing;
a refrigeration cycle including a compressor configured to compress and discharge refrigerant, a condenser configured to cause the refrigerant discharged from the compressor to dissipate heat, a pressure reducer configured to reduce a pressure of the refrigerant flowing out of the condenser, and an evaporator configured to evaporate the refrigerant reduced in pressure in the pressure reducer, the refrigeration cycle being disposed in the housing;
a warm air flow path which extends in a predetermined direction in the housing and through which air warmed by the condenser flows;
a cold air flow path which extends side by side with the warm air flow path in the housing and through which air cooled by the evaporator flows;
a warm air blower that includes a first actuator disposed in the warm air flow path and blows air in a first air-blowing direction by operation of the first actuator in the warm air flow path; and
a cold air blower that includes a second actuator disposed in the cold air flow path and blows air in a second air-blowing direction by operation of the second actuator in the cold air flow path, wherein
the condenser is disposed in the warm air flow path at an upstream side of the warm air blower in the air blowing direction, and
the evaporator is disposed in the cold air flow path at a downstream side of the cold air blower in the air blowing direction.
